(19) United States
(12) Patent Application Publication
(10) Pub. No.: US 2013/0278993 A1
(43) Pub. Date: Oct. 24, 2013

(54) COLOR-MIXING BI-PRIMARY COLOR SYSTEMS FOR DISPLAYS

(71) Applicants: Jason Heikenfeld, New Richmond, OH (US); Lisa Clapp, Cincinnati, OH (US); Stanislav G. Vilner, South Lebanon, OH (US); April Milarcik, Cincinnati, OH (US); Paul A. Merchak, Neuchatel (CH); Russell J. Schwartz, Cincinnati, OH (US)

(72) Inventors: Jason Heikenfeld, New Richmond, OH (US); Lisa Clapp, Cincinnati, OH (US); Stanislav G. Vilner, South Lebanon, OH (US); April Milarcik, Cincinnati, OH (US); Paul A. Merchak, Neuchatel (CH); Russell J. Schwartz, Cincinnati, OH (US)

(21) Appl. No.: 13/820,411

(22) PCT Filed: Sep. 1, 2011
(86) PCT No.: PCT/US11/50169

§ 371 Date: Jul. 15, 2013

Related U.S. Application Data
(60) Provisional application No. 61/379,578, filed on Sep. 2, 2010.

(51) Int. Cl. G02F 1/167

(52) U.S. Cl. CPC G02F 1/167
USPC 359/296

(57) ABSTRACT

A display pixel (10, 50). The pixel (10, 50) includes first and second substrates (12, 20, 60, 62) arranged to define a channel (16, 74). A fluid (26, 76) is located within the channel (12, 74) and includes a first colorant (36, 84) and a second colorant (38, 86). The first colorant (36, 84) has a first charge and color. The second colorant (38, 86) has a second charge that is opposite in polarity to the first change and a color that is complementary to the color of the first colorant (36, 84). A first electrode (22, 66), with a voltage source (32, 78), is operably coupled to the fluid (26, 76) and configured to moving one or both of the first and second colorants (36, 38, 84, 86) within the fluid (26, 76) and alter at least one spectral property of the pixel (10, 50).

### CROSS-REFERENCE TO RELATED APPLICATIONS

The present application claims the filing benefit of U.S. Provisional Application Ser. No. 61/379,578, filed Sep. 2, 2010, the disclosure of which is hereby incorporated by reference herein in its entirety.

### TECHNICAL FIELD

The present invention relates to electrofluidic devices generally and, more specifically, to electrophoretic devices.

### BACKGROUND

In conventional vertical electrophoretic displays, each pixel includes a black pigment and a white pigment suspended in oil. The white and black pigments are generally oppositely charged and the pigment surfaces are treated to prevent flocculation. The suspension is then placed into a channel of a pixel formed between two opposing substrates and electrodes for voltage control. Pigment movement is controlled by an electric field, with the time to move the pigment provided by V/μd², where V is the applied voltage, n is the electrophoretic mobility of the pigment, and d is the pixel height (or the distance between the opposing substrates). Accordingly, when a DC voltage is applied to the electrodes, the black pigments and the white pigments are driven to one of the opposing substrates of the pixel, based, in part, on the polarity of the applied voltage. Grayscale may be achieved in vertical electrophoretic device by only partially moving pigments across the pixel and between the opposite faces.

For in-plane electrophoretic displays, each pigment may be spread across the pixel area or collected to one side, location, or reservoir of the pixel. Only those pigments that are spread across the front substrate may absorb light. If both pigments are collected to the one side, then the pixel will provide a clear or light transparent state. Thus, multiple layers of pixels may be stacked, with the pixels of each layer containing subtractive colorants, to achieve bright color electronic paper (“e-paper”). However, stacked layer electrophoretic displays provide good color only when two pixels are stacked upon each other, which increases the manufacturing costs and limits the achievable pixel resolution. In-plane electrophoretic devices do generally have a better white state reflectance compared with vertical electrophoretic displays.

Full color e-paper may be generated by modulating light with the red, green, blue primaries (“RGB”) in an additive system or with the cyan, yellow, magenta primaries (“CYM”) in a subtractive system, or a subtractive/additive hybrid system using both RGB and CMY primaries in a cooperative “bi-primary” system. The key measures of performance of e-paper are white (“W”) state reflectance, the black (“K”) state reflectance (reflectance being critical for high contrast ratio), and the color gamut, including gray scale.

Side-by-side additive systems have been applied successfully to transmissive and emissive displays; however, use of the RGB color filter system in e-paper limits the color fraction (i.e., the effective area of the pixel at which a saturated color may be displayed) and the white state reflectance. White state reflectance may be increased with an unfiltered W sub-pixel, but these devices still have a less than satisfactory color fraction.

Theoretically, the subtractive CMY system improves color saturation and brightness but requires stacked pixels with each pixel in the stack switching between an optically clear state and one CMY color state. In theory, perfect white and color states may be achieved by a three pixel stack; however, optical loss, glare, pixel size, and costs greatly increase with each stacked layer.

The conventional bi-primary approach uses two non-mixing fluids, each having a different color, i.e., one CMY color and its complementary RGB color, and is described in detail in International Application No. PCT/US2010/45472, the disclosure of which is hereby incorporated herein by reference, in its entirety. Because the fluids of the conventional bi-primary device are “non-mixing,” the colors are not displayed over a common area. Therefore, K may only be displayed by adding a third fluid having a K color to the device.

There continues to be a need for a display device, suitable for implementation as full e-color paper, that is capable of high contrast, the full color gamut, low manufacturing costs, and video-switching speeds.

### SUMMARY OF THE INVENTION

In accordance with one embodiment of the invention an electrophoretic display pixel includes a first substrate, a second substrate arranged relative to the first substrate to define a channel, and a fluid located within the channel. The fluid includes a first colorant and a second colorant. The first colorant has a first charge and a color. The second colorant has a second charge that is opposite in polarity to the first charge and a color that is complementary to the color of the first colorant. At least one electrode, with a voltage source for electrically biasing the first electrode, is operably coupled to the fluid and configured to move one or both of the first and second colorants within the fluid and to alter at least one spectral property of the pixel.

In another embodiment, the present invention is directed to a display device that includes at least one pixel. First and second colorants are located within the at least one pixel with the second colorant having a color that is complementary to a color of the first colorant. An activation mechanism is operably coupled to the at least one pixel for applying a force thereto and that causes a color change in the pixel.

Still another embodiment of the present invention is directed to a method of generating a color that includes placing three pairs of complementary, oppositely charged colorants, into three different sub-pixels. Each pair of colorants is in a mixing relationship. Light is applied to the three sub-pixels containing the three pairs of complementary colorants.

In accordance with another embodiment of the present invention, a composition includes a fluid and first and second pluralities of particles within the fluid. The first plurality of particles has a first charge and a first color. The second plurality of particles has a second charge that is opposite in polarity as compared to the first charge and a second color that is complementary to the first color. The first and second pluralities of particles move differently within the fluid when a force that is applied to the fluid.

Still another embodiment of the present invention is directed to a method of dosing a display pixel. The display pixel includes a first substrate and a second substrate that is arranged relative to the first substrate to define a channel having a first volume. A second volume, being less than the first volume, of a fluid is injected into the channel. The fluid includes first and second charged colorants that are opposite in polarity and a first melting point. A temperature of the display pixel is lowered to less than the first melting point. A third volume of a solvent is injected into the channel and the temperature of the display pixel raised so that the fluid and solvent mix.

These and other advantages will be apparent in light of the following figures and detailed description.

### BRIEF DESCRIPTION OF THE FIGURES

The accompanying drawings, which are incorporated in and constitute a part of this specification, illustrate embodiments of the invention and, together with a general description of the invention given above and the detailed description given below, serve to explain the principles of the invention.

FIGS. 1A-1F are diagrammatic views of a horizontal, bi-primary, electrophoretic color system in accordance with one embodiment of the present invention and further illustrating a method of using the same.

FIG. 2 is a diagrammatic top view of a vertical, bi-primary, electrophoretic color system in accordance with another embodiment of the present invention.

FIG. 3 is a cross-sectional view through one sub-pixel of the vertical bi-primary, electrophoretic color system of FIG. 2, taken along line 3-3.

FIG. 4 is a diagrammatic view of various colors states that may be formed by the vertical, bi-primary electrophoretic color system of FIG. 2

### DETAILED DESCRIPTION

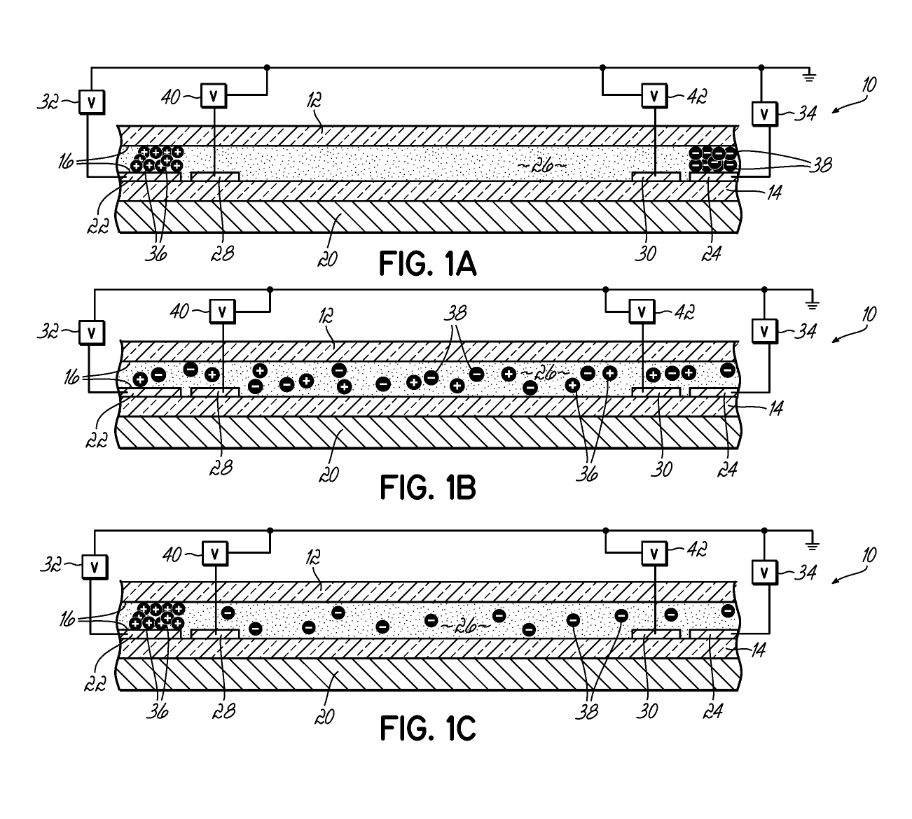

With reference to FIG. 1A, a horizontal electrophoretic pixel 10 in accordance with one embodiment of the present invention is shown. While the discussion of FIG. 1A is directed to a single pixel in a single layer, it would be understood that the illustrative embodiment of FIG. 1A may also be applied to multiple pixels in a layered configuration and/or pixels that are further subdivided into two or more sub-pixels, as is discussed in greater detail below.

The pixel 10 includes a first substrate 12 and a second substrate 14 that is arranged with respect to the first substrate 12 to form a channel 16. At least one of the first and second substrates 12, 14 may be transparent, which is specifically shown in FIG. 1A as the first substrate 12. However, other arrangements may be known and used if desired.

The second substrate 14 may include a reflector 20, which includes any material that reflects light including, for example, colorants, paper, metals, thin film dielectric mirrors, or others that are generally known. Alternatively, the second substrate 14 is transparent and the reflector 20 replaced by a backlight unit or a transflective backlight. The optics and requirements for transmissive and transflective displays are well known by those skilled in the art of displays, and are included as alternate embodiments of the present invention.

At least two control electrodes 22, 24 are positioned at opposing ends of the channel 16 and are in operable contact with a fluid 26 that is located within the channel 16. The particular illustrative embodiment further includes two optional gate electrodes 28, 30. Other configurations of the control electrodes 22, 24, with or without the gate electrodes 28, 30 would be known to those of ordinary skill in the art.

At least two voltage sources 32, 34 are electrically coupled to a corresponding one of the control electrodes 22, 24 and are configured to apply an electric field to the fluid 26 within the channel 16 so as to move one or more colorants 36, 38 dispersed within the fluid 26. Because the illustrative embodiment includes optional gate electrodes 28, 30, additional voltage sources 40, 42 are included to electrically couple to a corresponding one of the gate electrode 28, 30. The voltage sources 32, 34, 40, 42 may be connected to a common ground, which may be external to the pixel 10, as would be understood by one of ordinary skill in the art. Accordingly, various drive schemes are known and may be implemented as is known by those of ordinary skill in the art.

Turning now to the details of the fluid 26, the fluid 26 can include a polar solvent and/or a non-polar solvent. Non-limiting examples of the polar solvent include water, glycols, polyglycols, alcohols, polyols, ethers, esters, ketones, ketals, lactones, lactams, pyrrolidones and polyvinylpyrrolidones, pyrrolidines, carbonates, sulfones, sulfoxides, amines, amides, imines, nitriles, carboxylic acids, acetals, carbamates, ureas, aldehydes, halogenated, thio, or nitro compounds, ionic fluids, fluoro- and other non-hydrocarbon-based solvents, or any mixtures thereof. Non-limiting examples of non-polar solvents include non-substituted linear and branched alkanes and their derivatives, for example, halogenated alkanes, substituted and unsubstituted aromatic hydrocarbons and partially hydrogenated aromatic hydrocarbons, organometallic compounds such as silicones, fatty alcohols, carboxylic acids, esters, and amides, or any mixtures thereof. Generally it is desired that solvent partially including the fluid 26 is sufficiently electrically insulating such that it will support electric field adequate for movement of charged particles.

The fluid also includes at least two colorants 36, 38. Each colorant 36, 38 is charged (first colorant 36 having a charge, “+,” opposing the polarity of a charge, “−,” of the second colorant 38), is complementary (first colorant 36 has a color that is complementary to a color of the second colorant 38 and vice versa). The charge may be a surface charge, a charged embedded inside the colorant, or combinations thereof. Complementary colors are those which do not possess a significant common transmission or reflectance in the visible spectrum, but which together, cover the full visible spectrum, e.g., provide a substantially achromatic color. The first colorant 36 may be selected from the primary colors of the RGB additive system and the second colorant 38 may be selected from the primary colors of the CMY subtractive system. Example complementary pairs may include, for example, RC, GM, and BY, wherein the complements are selected based, at least in part, on the wavelengths of each and may, in fact, include any wavelength in the electromagnetic spectrum (and not limited to just visible wavelengths). The colorants 36,38 can be refractive index matched to the solvent comprising fluid 26 such that the colorants 36, 38 are purely light filtering (not reflecting or optically scattering). The colorants 36, 38 may further include a reflecting pigment (such as TiO₂), or themselves have physical properties that result in reflection.

If so desired, additional colorants may be included in the fluid 26, including other primaries from RGBCYM and/or WK, i.e., white (“W”) or black (“K”), or gray colorants.

Each colorant 36, 38 may be one or more pigments, a dye, a colored particle, a colored fluid or emulsion, or any combination thereof. The colored fluids may be, for example, a liquid or a gas. For those embodiments in which the colored fluid is a gas, the colorant 36, 38 may be a liquid powder, such as those that are commercially available from Bridgestone Corp (Kyobashi, Tokyo, Japan).

The pigment may include any organic pigment belonging to an azo and azo condensed, metal complex, benzimidazolone, azomethine, methane, anthraquinone, phthalocyanine, perinone, perylene, diketopyrrolopyrrole, indigo, thioindigo, dioxazine, isoindoline, isoindolinone, iminoisoindoline, iminoisoindolinone, quinacridone, flavanthrone, indanthrone, anthrapyrimidine, naphthalimide, quinophthalone, isoviolanthrone, pyranthrone pigments, or carbon black, or any combination and solid solution thereof.

The pigment may be any inorganic pigment such as metal oxide, mixed metal oxide, antimony yellow, lead chromate, lead chromate sulfate, lead molybdate, ultramarine blue, cobalt blue, manganese blue, chrome oxide green, hydrated chrome oxide green, cobalt green, metal sulfides, cadmium sulfoselenides, zinc ferrite, bismuth vanadate, or derivatives thereof.

The pigment may also be any known extenders, for example carbonates, sulfates, phosphates, and can be synthetic or mineral.

The pigment may also be a dispersed polymer, such as polystyrene, polyamides, polysulfones, or polysulfides. The pigment also can be any mixture of organic, inorganic pigments and extenders, and solid solutions thereof. In addition, the pigment may be any encapsulated organic or inorganic pigment or extender, or shell type pigment with inorganic nuclei covered with organic shell and vice versa.

The pigment may be a surface modified pigment made by methods of chemical modification by covalently attaching ionic, nonionic, or polymeric groups to the pigment surface. Non-limiting examples of modifying groups are carboxylic, sulfonic, phosphate, hydroxyl, polyalkylenglycol, polyalkylene, polyakylenimine, polyurethane, polyuria, polyamide, and polyester-groups, or any combinations thereof.

The dye that is included in the fluid 26 can be any conventional dye including, for example, direct, acid, basic (cationic), reactive, vat, sulfur, solvent, food, mordant, fluorescent, natural, and disperse dye, or any combination thereof. It can be also a complex of any anionic dye with any cationic dye.

The dye that is included in the fluid 26 also can include a chromophore such as an azo or azo condensed, a metal complex, benzimidazolones, azomethines, methines such as cyanines, azacarbocyanines, enamines, hemicyanines, streptocyanines, styryls, zeromethines, mono-, di-, tri-, and tetraazamethine; caratenoids, arylmethane such as diarylmethanes and triarylmethanes; xanthenes, thioxanthenes, flavanoids, stilbenes, coumarins, acridenes, fluorenes, fluorones, benzodifuranones, formazans, pyrazoles, thiazoles, azines, diazines, oxazines, dioxazines, triphenodioxazines, phenazines, thiazines, oxazones, indamines, nitroso, nitro, quinones such as hydroquinones and anthraquinones; rhodamines, phthalocyanines, neutrocyanines, diazahemicyanines, porphirines, perinones, perylenes, pyronins, diketopyrrolopyrroles, indigo, indigoids, thioindigo, indophenols, naphthalimides, isoindolines, isoindolinones, iminoisoindolines, iminoisoindolinones, quinacridones, flavanthrones, indanthrones, anthrapyrimidines, quinophthalones, isoviolanthrones, pyranthrones, or any combination thereof.

The dye may be polymeric or non-polymeric. The dye may also be utilized as a colorant, a shader, a charging agent, for pigment surface modification to improve dispersion and stabilization of pigment particles in the fluid, for improvement of rheological properties, and/or for adjustment of interfacial tension, surface tension, and conductivity of the fluid.

The dye portion of the colorants 36, 38 may be partially to fully soluble in the fluid 26 or may act as a dispersant, particularly when used in combination with a particle or pigment particle. Dispersed pigment may be in the form of individual particles, aggregates, agglomerates or combinations. Particles that are substantially insoluble in the fluid 26 may be composed of one or more materials, may be homogenous or heterogeneous (each heterogeneous region may itself be homogenous and/or heterogeneous). Accordingly, the pigment may include one or more chemical modification so as to embed the pigment within the particle, couple the pigment to the surface of the particle, or both. The pigment particles may be fully or partially encapsulated, generating particles containing pigments of individual core/shell pigment structure or of multiple pigments encased in a structure. The shell or encasing material may be polymeric or non-polymeric in nature. The chemical modification of the particle or pigment or the shell or encasing material may provide functional properties such as a rate or level dispersion, a level of dispersion stability, a charge or a level of charge to the pigment. Where a chemical modification of the pigment surface becomes substantially large it becomes an individual core/shell pigment structure or a multiple pigment encased structure if more than one pigment particle forms a particle. Similarly, the dye may be encased in a polymer or non-polymer structures.

The total colorant content of the fluid 26 can be in the range from 0.01% weight to 50% weight, based on the total weight of the fluid 26. In another example, the colorant content is in the range from about 0.5% weight to 25% weight, based on the total weight of the fluid. In yet another example, the colorant content is in the range from about 0.1% weight to about 20% weight, based on the total weight of the fluid 26. In another example, the colorant content is in the range from about 1% weight to 15% weight, based on the total weight of the fluid 26. In still another example, the colorant content is in the range of about 1% weight to about 10% weight, based on the total weight of the fluid 26. In another example, the colorant content is in the range of about 2% weight to about 5% weight, based on the total weight of the fluid 26.

If desired, a surfactant may be included in the fluid 26. The surfactant may be any anionic, cationic, catanionic, zwitterionic (amphoteric), non-ionic surfactant, or combinations thereof. The surfactant may be used for better dye solubility, colloid stabilization of pigment particles in fluid, to impart a charge to the colorant particles, and to lower interfacial or surface tension.

If desired, a synergist may be included in the fluid 26. The synergist may be sulfonic acid, a metal salt of sulfonic acid, a salt of sulfonic acid with primary, secondary, tertiary, and quaternary amines; a sulfonamide, phthalimidomethyl, arylmethyl, alkyl amine, carboxylic acid, salts, amides and esters of carboxylic acids; a carbonyl, amidomethyl, alkylaminomethyl, arylalkyloxy, phenylthio and phenylamino derivatives of azo, metal complex, benzimidazolone, azomethine, methane, anthraquinone, phthalocyanine, perinone, perylene, diketopyrrolopyrrole, indigo, thioindigo, dioxazine, isoindoline, isoindolinone, iminoisoindoline, iminoisoindolinone, quinacridone, flavanthrone, indanthrone, anthrapyrimidine, quinophthalone, isoviolanthrone, pyranthrone pigments, or any mixtures thereof. The synergist can also be any commercial or modified direct, acid, cationic, reactive, vat, sulfur, and disperse dye or any combination thereof. The synergist may be used for pigment surface modification, to stabilize pigment particles in the fluid 26, to improve rheological properties, and to impart a charge to the colorants 36, 38.

If desired, a polymeric dispersant may optionally be used with or without the synergist to assist in stabilizing the pigment in the fluid 26 and to impart a charge to the particles. The dispersant may be selected from the following classes: anionic, cationic, and zwitterionic (amphoteric), non-ionic polymer that is block, random, comb polymer or co-polymer, or combinations thereof.

Soluble colorants may include dyes; however, in some embodiments, the dye is absorbed onto the pigment or a particle surface, thus rendering the dye insoluble in the fluid 26.

The fluid 26 in which the colorants 36, 38 are dispersed may also be polymeric or non-polymeric in nature. In another case, the pigment particle or particle has materials on the inside and/or on the surface of the particle to provide functional properties such as a rate or degree of dispersion, a level of dispersion stability, a charge or a level of charge to the particle. Fluids that may be utilized in the devices may include, for example, those fluids that are described in detail in International Application Nos. PCT/US2010/061287, PCT/US2010/044441, and PCT/US2010/000767, the disclosures of which are hereby incorporated herein by reference in their entirety.

Referring still to FIG. 1A, as well the subsequent FIGS. 1B-1E, a method of moving the colorants 36, 38 is described in accordance with one embodiment of the present invention. In FIG. 1A, a negative biasing voltage is applied to the first control electrode 22 and a positive biasing voltage is applied to the second control electrode 24. As a result, the colorants 36, 38 move toward the biased control electrode 22, 24 that opposes the polarity of the colorant 36, 38, i.e., the first colorant 36, being a cation, is electrostatically drawn toward the negatively biased first control electrode 22 and the second colorant 38, being an anion, is electrostatically drawn toward the positively biased second control electrode 24. Said another way, the first and second colorants 36, 38 are in a first dispersion state, i.e., the colorants 36, 38 are separated. It would be readily appreciated that the first and second colorants 36, 38 may include a distribution of various sizes and that certain ones of the first and second colorants 36, 38 having a particular size may respond differently to the positive bias as compared to other ones of the first and second colorants 36, 38. The color state of the pixel in FIG. 1A would therefore be the color of the second substrate 14 or the reflector 20, e.g., white.

In FIG. 1B, the biasing voltages are removed from the control electrodes 22, 24 and the colorants 36, 38 move throughout the channel 16 under thermodynamic and electrostatic forces. Alternatively, to increase the speed at which the colorants 36, 38 move from the positions shown in FIG. 1A, the voltage potential for each control electrode 22, 24 may be briefly reversed. In either situation, the color state of the pixel 10 in FIG. 1B is black or gray because of the complementary nature of the mixed first and second colorants 36, 38, e.g., the colorants 36, 38 are in another dispersion state.

Returning again to FIG. 1A, and now with reference to FIG. 1C, the second colorant 38 is moved from a region of the channel 16 proximate to the second control electrode 24 and into the channel 16 by reversing or removing the voltage potential on the second control electrode 24. If so desired, a positive bias voltage may be applied to the first gate electrode 28, which both electrostatically draws the second colorant 38 into the channel 16 and further resists movement of the first colorant 36 into the channel 16. The color state of the pixel 10 in FIG. 1C is the color of the second colorant 38.

FIG. 1D is similar to FIG. 1C but with the first colorant 36 moving into the channel 16 while the second colorant 38 is retained at the region proximate to the second control electrode 24. Therefore, the color state of the pixel 10 in FIG. 1D is the color of the first colorant 36.

FIG. 1E is similar to FIG. 1D in that the first colorant 36 is moved into the channel 16 while the second colorant 38 is retained at the region proximate to the second control electrode 24. However, in FIG. 1E, the biasing voltages applied to the first control electrode 22 and the first and second gate electrodes 28, 30 are such that the first colorant 36 is only partially moved into the channel 16. Therefore, the color state of the pixel 10 in FIG. 1E is similar to the color state in FIG. 1D but the color is lighter, whiter, or less saturated.

As is shown in FIG. 1F, the pixel 10 may also display a gray state. That is, biasing voltage potentials are applied to the first and second control electrodes 22, 24 so that the first and second colorants 36, 38 are only partially moved into the channel 16. A partial mixing of the first and second colorants 36, 38 would therefore be observed as gray.

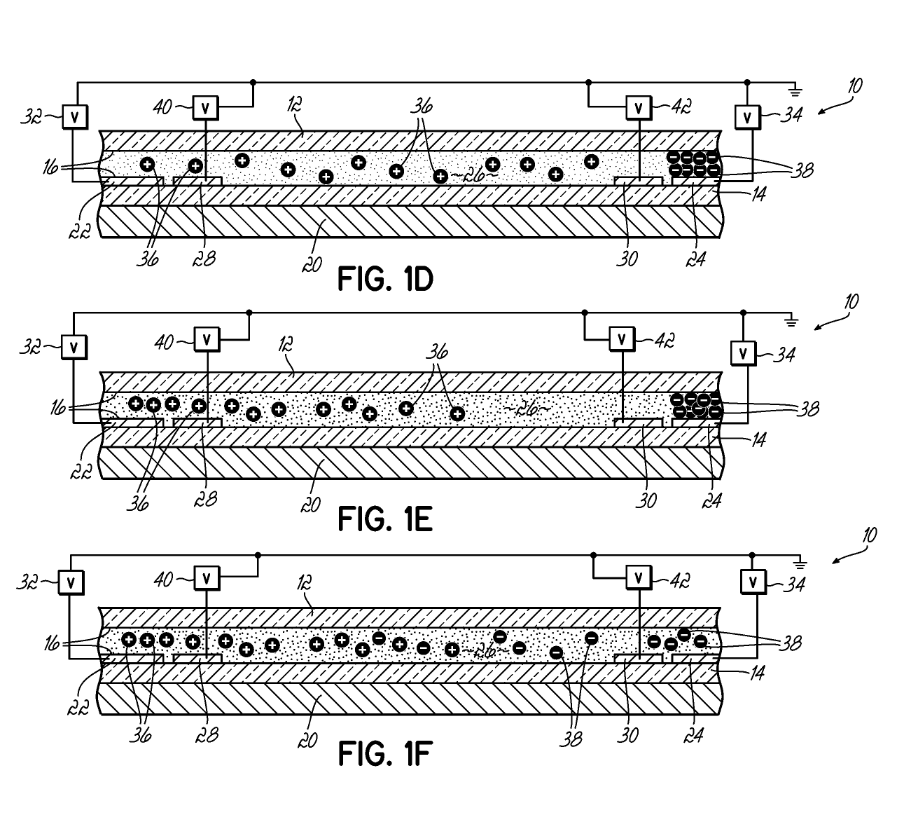

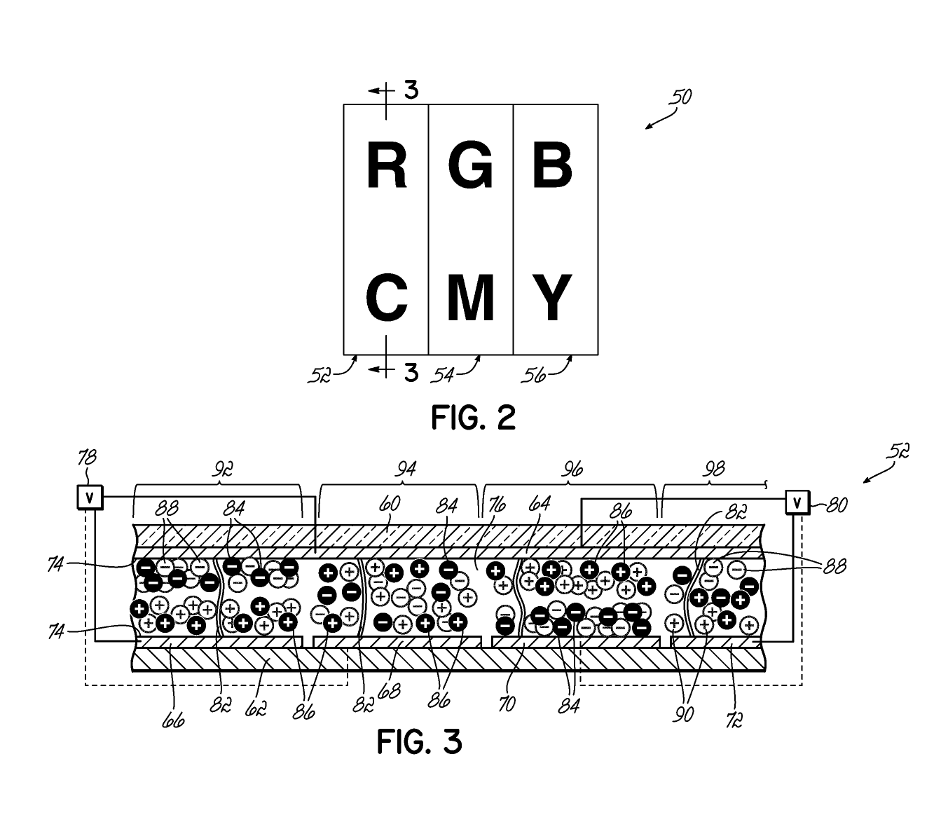

FIG. 2 is a top view of a vertical, bi-primary electrophoretic pixel 50 in accordance with another embodiment of the present invention and FIG. 3 is a cross-section through one sub-pixel of the pixel 50. The pixel 50 comprising at least three sub-pixels 52, 54, 56, each constructed in a similar way, wherein the first sub-pixel 52 includes a red colorant (illustrated as “R”) and a cyan colorant (illustrated as “C”), the second sub-pixel 54 includes a green colorant (illustrated as “G”) and a magenta colorant (illustrated as “M”), and the third sub-pixel 56 includes a blue colorant (illustrated as “B”) and a yellow colorant (illustrated as “Y”). While the pixel 50 of FIG. 2 is described in greater detail with reference to FIG. 3, one of ordinary skill will appreciate that the device 10 of FIG. 1 may also include a plurality of sub-pixels similar to the embodiment of FIG. 2.

With reference now to FIG. 3, each sub-pixel (although only the first sub-pixel 52 is shown) includes a transparent first substrate 60, a second substrate 62, a transparent electrode 64 (for example, indium tin oxide (“ITO”), indium zinc oxide (“IZO”), or organic transparent conductors such as PEDOT, Pac, Pani, and so forth), and a plurality of control electrodes 66, 68, 70, 72 located within the channel 74 and is operably coupled to the fluid 76 within the channel 74. One or more voltage sources 78, 80 are electrically coupled to the electrode 64 and the control electrodes 66, 68, 70, 72 for applying a biasing voltage thereto. The first sub-pixel 52, as shown, may be further divided by one or more borders 82, which may be polymeric or other materials, commonly employed to provide local fluid confinement and physical robustness in electrophoretic or cholesteric liquid crystal displays.

The first sub-pixel 52 of FIG. 3 includes an anionic red colorant 84 (illustrated as dark circles with “−”), a cationic cyan colorant 86 (illustrated as dark circles with “+”), an anionic white colorant 88 (illustrated as white circles with “−”), and a cationic white colorant 90 (illustrated as white circles with “+”). While each division of the first sub-pixel 52 is shown in a different color state, it would be understood that this is for illustrative convenience and that in practice the first sub-pixel 52 may have the same color state between all divisions thereof.

In use, the first sub-pixel 52 may display a red color state (shown in a first division 92 of the first sub-pixel 52) by applying a first voltage to the electrode 64 and a negatively biased voltage to the control electrode 66, which causes the anionic red and white colorants 84, 88 to move toward the first substrate 60 while the cationic cyan and white colorants 86, 90 move toward the second substrate 62. The first sub-pixel 52 may also display black or gray (shown in a second division 94 of the first sub-pixel 52) by grounding the transparent electrode 64 and applying a positively bias voltage potential followed by a shorter negatively bias voltage potential to the control electrodes 68, 70, which causes the cationic and anionic colorants 84, 86, 88, 90 to mix throughout the channel 74. A cyan color state (shown in a third division 96 of the first sub-pixel 52) may be achieved in a manner that is similar for the red color state but for a positively biased voltage applied to the control electrode 70. The positively biased control electrode 70 causes the anionic colorants 84, 88 to migrate toward the second substrate 62 and the cationic colorants 86, 90 to move toward the first substrate 60. A dark red color state (shown as division 98 of the first sub-pixel 52) may be achieved by control electrode 72 moving the anion red and white colorants 84, 88 only slightly above the cation cyan and white colorants 86, 90.

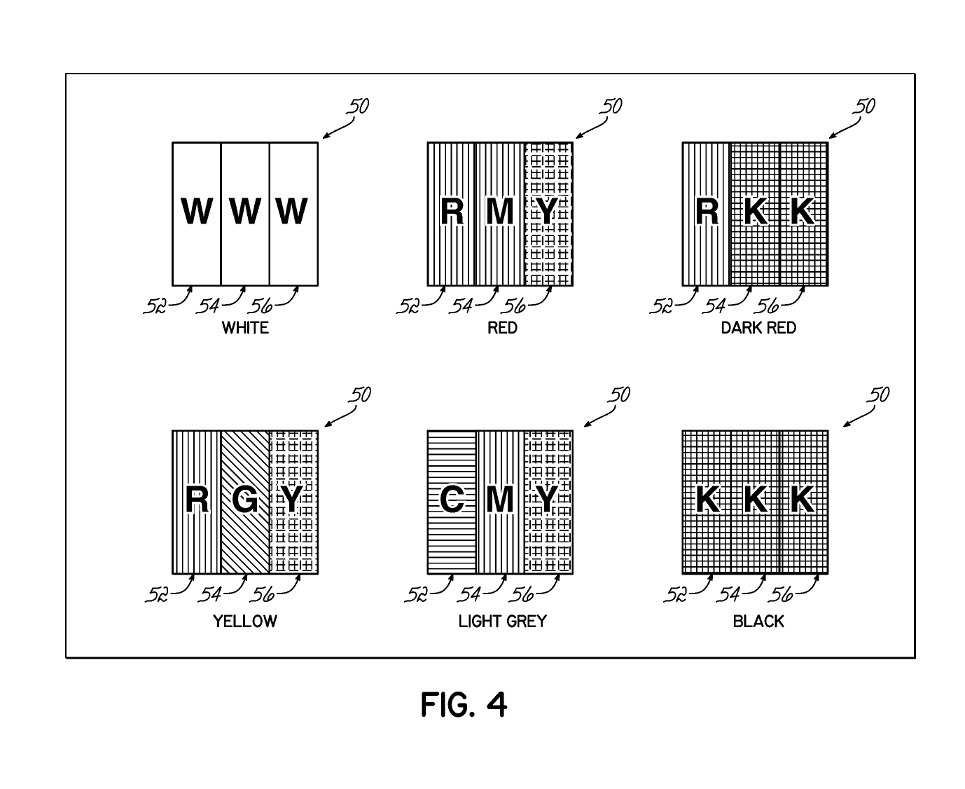

By independently controlling the color state of the sub-pixels 52, 54, 56 (FIG. 2), various color states for the pixel 50 (FIG. 2) may be achieved, as shown in FIG. 4. Certainly, the color states shown in FIG. 4 are not inclusive of all possible color states. For example, a M pixel may be achieved by displaying sub-pixels with RMB; a C pixel may be achieved by displaying sub-pixels with CGB; a G pixel may be achieved by displaying sub-pixels with CGY; and a B pixel may be achieved by displaying sub-pixels with CMB. Alternatively, a dark B pixel (albeit lower reflectance) may be achieved by KKB. Alternatively, a light B pixel (albeit higher reflectance) may be achieved by WWB. Other color states and mixtures thereof are possible.

If desired, additional CMY or W boosting sub-pixel(s) (not shown) may be provided to balance the performance for all pixels, and/or the colorants may be modified to be non-pure in color, such that as a system, the bi-primary pixel 50 more evenly supports RGB, white, and CMY color reflectance. Also, cyan, yellow, and magenta colors already have a desaturated color appearance, so, for example, to create a brighter yellow pixel (at the cost of color saturation) the red and green sub-pixel 52 may be whitened by displaying less pigment across the pixel 50.

It would be appreciated by one of ordinary skill in the art that the horizontal (FIG. 1A) and the vertical (FIGS. 2 and 3) electrophoretic pixels 10, 50 may also be used in various other devices, such as electrokinetic display devices from Hewlett Packard Company (Palo Alto, Calif.). Accordingly, and in this embodiment, the bi-primary colorants may be mixed in a single solvent and implemented into a single layer device.

In another embodiment, the bi-primary operation may also be achieved by stacking or mixing two electrochromic materials, or two electronic layers. The first electrochromic material or layer may include CMY sub-pixels and the second electrochromic material or layer may include RGB sub-pixels that are aligned with the respective complementary color sub-pixel of the first material or layer. The electrochromic materials or layers may then be operated to switch between RGB, CMY, and clear states, thus allowing for all of the mixed colors that are possible for the bi-primary color system. Electrochromism is well understood by those of ordinary skill in the art of displays and stacked CMY displays have been demonstrated by Ricoh Corp. (Chuo-ku, Tokyo, Japan) and side-by-side RGB displays have been demonstrated by Samsung Corp. (Samsung Town, Seoul, South Korea).

In still another embodiment, the bi-primary operation may be achieved by use of magnetically-driven colorants that are complementary in color, may be utilized in liquid-crystal technologies, including, for example, cholesteric liquid crystals in development by Kent Displays (Kent, Ohio) or dyed liquid crystals, such as guest-host liquid crystal systems. Alternatively still, the bi-primary operation may also be achieved by suspended particle technology, wherein the suspended particles have a color, a rod-like geometry, and rotate in the presence of an electric field. Therefore, two or more such particles, of complementary colors, may be included in each pixel.

Still other embodiments may include fluids having first and second colorants of complementary colors in a pixel device and that is responsive to a particular activation mechanism, for example, an electric field, a magnetic field, electrochemistry, mechanical forces, thermal changes, optical changes, or other stimuli and/or forces that are known to those of ordinary skill in the art of displays, rewritable paper, printing, color-changing surfaces, and so forth.

These various embodiments may be implemented as a single pixel, two pixels that are horizontally or vertically arranged and optically aligned, or various layers of a plurality of pixels that are horizontally or vertically arranged and optically aligned so as to provide the same optically filtered color as though the fluids of the pixels are mixed.

In constructing the bi-primary electrophoretic pixels 10, 50, one exemplary method may include injecting the fluids 26, 76 using any one of various dosing methods, including, for example, inkjet or digital printing. For example, each fluid 26, 76 containing its respective colorants 36, 38, 84, 86, 88, 90, as described previously, may be dispensed, such as by inkjet printing, into the pixel 10 or a respective one of the sub-pixels 52, 54, 56. Concerning the sub-pixels, 52, 54, 56, the fluid 76 may be dosed to a volume that is only a fraction of a total volume of the sub-pixel 52, 54, 56 and because the walls of the sub-pixel 52, 54, 56 form a microfluidic discontinuity that is caused by, for example, an increase in the Laplace pressure, contact angle hysteresis, and/or Gibbs contact line pinning Because the fluids 26, 76 contain at least two colorants 36, 38, 84, 86, 88, 90, the freezing point of the fluids 26, 76 is lower than the freezing point of the solvent alone and may be, for example, about 10 ° C. After the pixel 10 or one or more sub-pixels 52, 54, 56 is dosed, the temperature of the pixel 10, 50 is lowered to less than 10° C., thereby freezing the fluids 26, 76. A second solvent, one having a lower freezing point than the freezing point of the fluid 26, 76, is added to the pixel 10 or the one or more sub-pixels 52, 54, 56 and the substrates bonded using techniques that are conventionally used in liquid crystal and electrophoretic displays. The pixels 10, 50 are then brought to room temperature, the fluid 26, 76 melts, and the fluid 26, 76 with the colorants 36, 38, 84, 86, 88, 90 is mixed with the second solvent. The combined mixture of the fluid 26, 76 and the solvent may then satisfy the environmental operation and storage temperature requirements for consumer electronics.

As provided in detail herein, a bi-primary electrophoretic pixel is described that includes two primary colorants that may be mixed to achieve black or gray, the pixel construction minimizes the amount of fluid and colorant required, minimizes the complexity of construction, allows higher pixel resolution, and the pixel may include a number of sub-pixels having its own volume of the fluid to achieve a wide range of displayed colors.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes,” “having,” “has,” “with,” “composing,” or variants thereof are used in either the detailed description or the claims, such terms are intended to be inclusive in a manner similar to the open-ended term “comprising.”

While the invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. Thus, the invention in its broader aspects is therefore not limited to the specific details, representative apparatus and method, and illustrative example shown and described. Accordingly, departures may be made from such details without departing from the spirit or scope of the general inventive concept.

What is claimed is:

1. A display pixel comprising:
a first substrate;
a second substrate arranged relative to the first substrate to define a channel;
a fluid located within the channel;
a first colorant in the fluid, the first colorant having a first charge, and the first colorant having a non-black color;
a second colorant in the fluid, the second colorant having a second charge opposite in polarity to the first charge, and the second colorant having a non-black color that is complementary to the color of the first colorant;
at least one electrode operably coupled to the fluid; and
a voltage source coupled to the at least one electrode, the voltage source being configured to supply an electrical bias to the at least one electrode to cause at least one of the first and second colorants to move within the fluid;
wherein movement of at least one of the first and second colorants alters at least one spectral property of the pixel.

2. The display pixel of claim 1, wherein the first and second colorants are dispersed or dissolved in the fluid.

3. The display pixel of claim 1, wherein the fluid is visible through at least one of the first and second substrates.

4. The display pixel of claim 1, wherein the at least one spectral property is light reflectance from or transmission through the pixel.

5. The display pixel of claim 1, wherein the at least one spectral property is color.

6. The display pixel of claim 5, wherein the observed color is black.

7. The display pixel of claim 1, wherein the fluid is visible through the first substrate, the display pixel further comprising:
a white reflector located proximate to the second substrate, wherein when the electrical bias moves the first and second colorants to opposing ends of the channel and the white reflector is visible through the first substrate.

8. The display pixel of claim 1 further comprising:
at least one barrier located within the channel and configured to divide the channel into two or more divisions.

9. The display pixel of claim 1, wherein the fluid is visible through the first substrate, the display pixel further comprising:
a backlight positioned proximate to the second substrate and configured to transmit light through the channel and the first substrate.

10. The display pixel of claim 1, wherein at least one of the first and second colorants includes a pigment.

11. The display pixel of claim 1, wherein at least one of the first and second colorants is a dye.

12. The display pixel of claim 1, wherein the fluid is a gas, and the first and second colorants are liquid powders.

13. The display pixel of claim 1 further comprising:
a third colorant located within the fluid, wherein the third colorant includes a white pigment and is operable to increase reflectance.

14. A display comprising a plurality of electrophoretic display pixels of claim 1.

15. The display of claim 14, wherein the plurality of electrophoretic display pixels comprises at least three pixels, the display further comprising:
a first fluid located within a first pixel, the first fluid having a red-based colorant and a cyan-based colorant;
a second fluid located within a second pixel, the second fluid having a green-based colorant and a magenta-based colorant; and
a third fluid located within a third pixel, the third fluid having a blue-based colorant and a yellow-based colorant.

16. A display device comprising:
at least one pixel;
a first colorant located within the at least one pixel, the first colorant having a color;
a second colorant located within the at least one pixel, the second colorant having a color that is complementary to the color of the first colorant; and
an activation mechanism operably coupled to the at least one pixel and configured to apply a force that causes a color change in the pixel.

17. The display device of claim 16, wherein the first and second colorants differ by at least one physical property.

18. The display device of claim 17, wherein the at least one physical property is property charge.

19. The display device of claim 16 further comprising:
a first sub-pixel within the at least one pixel containing a red-based colorant and a cyan-based colorant;
a second sub-pixel within the at least one pixel containing a green-based colorant and a magenta-based colorant;
a third sub-pixel within the at least one pixel containing a blue-based colorant and a yellow-based colorant;
wherein the respective colorants in one or more of the first, second, and third sub-pixels are mixed or separated to alter at least one spectral property of light that is incident on the at least one pixel.

20. The display device of claim 16, wherein the activation mechanism is one of an electric field, a magnetic field, or electrochromism.

21. The display device of claim 16, wherein at least one of the first and second colorants contains a pigment.

22. The display device of claim 16, wherein at least one of the first and second colorants contains a dye.

23. A method of generating color, the method comprising:
placing a first pair of complementary colorants in a first mixing relationship in a first sub-pixel;
placing a second pair of complementary colorants in a second mixing relationship in a second sub-pixel that is proximate to the first sub-pixel;
placing a third pair of complementary colorants in a third mixing relationship in a third sub-pixel that is proximate to at least one of the first and second sub-pixels; and
applying light to the first, second, and third regions.

24. The method of claim 23, wherein the colorants comprising the first, second, and third pairs are oppositely charged.

25. The method of claim 23, wherein the first pair comprises a red-based colorant and a cyan-based colorant, the second pair comprises a green-based colorant and a magenta-based colorant, and the third pair comprises a blue-based colorant and a yellow-based colorant.

26. The method of claim 23, wherein one of the first, second, or third mixing states is one of separated or mixed.

27. A composition comprising:
a fluid;
a first plurality of colorants within the fluid, the first plurality of colorants having a first color; and
a second plurality of colorants within the fluid, the second plurality of colorants having a second color, the first and second colors being complements,
wherein the first plurality of colorants and the second plurality of colorants move differently within the fluid when a force is applied to the fluid.

28. The composition of claim 27, wherein the first and second pluralities of colorants are dispersed or dissolved in the fluid.

29. The composition of claim 27, wherein the first plurality of colorants have a first charge and the second plurality of colorants have a second charge that is opposite in polarity as compared to the first charge and.

30. The composition of claim 29, wherein the force is an electric field.

31. The composition of claim 27, wherein the first and second colors are at least one of red and cyan, green and magenta, and blue and yellow.

32. The composition of claim 27, wherein applying the force moves one of the first plurality of colorants or the second plurality of colorants or both from a first dispersion state to a second dispersion state and causes a change in at least one spectral property of the fluid.

33. The composition of claim 27, wherein the fluid is a gas.

34. The composition of claim 27, wherein the fluid is a liquid.

35. A method of dosing a display pixel, wherein the display pixel includes a first substrate and a second substrate arranged relative to the first substrate to define a channel having a first volume, the method comprising:
injecting a second volume of a fluid into the channel, the fluid having a first charged colorant and a second charged colorant that is opposite in polarity to the first charged colorant and the fluid has a first melting point, wherein the second volume is less than the first volume;
lowering a temperature of the display pixel to less than the first melting point;
injecting a third volume of a solvent into the channel, the solvent having a second melting point that is lower than the first melting point; and
raising the temperature of the display pixel to more than the first melting point such that the fluid and the solvent mix.

36. The method of claim 35 further comprising:
sealing the channel before raising the temperature of the display pixel.

37. The method of claim 35, wherein the display pixel includes a plurality of sub-pixels, each of the plurality of sub-pixels containing the fluid, the fluid of each of the plurality of sub-pixels includes a different first and second charged colorants, the method further comprising:
injecting the fluid with the different first and second charged colorants into a respective one of the plurality of sub-pixels.

38. The method of claim 35, wherein the first colorant has a first color and the second colorant has a second color that is complementary to the first color.

39. The method of claim 35, wherein the third volume is the difference between the first and second volumes.
